(19) United States
(12) Patent Application Publication
(10) Pub. No.: US 2008/0047268 A1
(43) Pub. Date: Feb. 28, 2008

(54) Controller for turbocharger with electric motor

(75) Inventors: Nobumasa Isogai, Hekinan-city (JP); Yuuji Ishiwatari, Kariya-city (JP); Hisaharu Morita, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/889,575

(22) Filed: Aug. 14, 2007

(30) Foreign Application Priority Data
Aug. 23, 2006 (JP) 2006-227169

(51) Int. Cl. F02B 39/00

(52) U.S. Cl. 60/608

(57) ABSTRACT

A controller controls an electrically assisted turbocharger including a turbocharger body and an assist electric motor for assisting the turbocharger body in driving. The controller controls the operation of the assist electric motor. The controller compares a target power value of the assist electric motor with an actual power value actually supplied to the assist electric motor, and computes the differential between them. The controller compensates a torque error of the assist electric motor due to the differential (updating a correction coefficient) based on the differential.

### CROSS-REFERENCE TO RELATED APPLICATION

This application is based on Japanese Patent Application No. 2006-227169 filed on Aug. 23, 2006, the disclosure of which is incorporated herein by reference.

### FIELD OF THE INVENTION

The present invention relates to a controller for a turbocharger with electric motor. The assist electric motor is installed in a turbocharger body and assists (helps) the turbocharger in driving. The controller controls the operation of the assist electric motor (assist motor)

### BACKGROUND OF THE INVENTION

In general, a turbocharger is so constructed that a turbine and a compressor are provided at ends of a shaft. The turbine is rotated by an exhaust gas, and the compressor can be driven by its power. By this driving of the compressor, an engine is supplied with a pressure higher than the atmospheric pressure. Supercharging is carried out in an engine air intake system by such a turbocharger, and increase in engine torque and the like can be thereby achieved.

JP-A-2005-42684 (U.S. Pat. No. 7,084,600 B2) shows a turbocharger with electric motor. An electric motor (assist electric motor) is installed on the shaft of the turbocharger to assist the turbocharger in driving. In this turbocharger with electric motor, an engine response can be improved in transition from a low rotation range to a high rotation range (acceleration) of the engine.

Here, description will be given to an alternating current-driven electric induction motor using a cage rotor as an example of a widely known conventional assist electric motor with reference to FIGS. 12A to 12C. FIG. 12A is a perspective view illustrating the general configuration of a cage rotor used in this electric motor. FIG. 12B is a sectional view schematically illustrating the structure of the axial plane of the iron core of the rotor. FIG. 12C is a drawing illustrating an end ring used in the rotor as viewed from the axial direction.

This electric induction motor is formed by providing the cage rotor 51 as a rotor as illustrated in FIG. 12A with an exciting coil (not shown) as a stator that encircles the rotor 51. In the axial center of the rotor 51, there is installed a rotating shaft 53 as an output shaft. Thus, the rotor 51 is encircled with the exciting coil.

As illustrated in FIG. 12A, the rotor 51 is in substantially columnar shape and includes an iron core 511. The iron core 511 is constructed by laminating substantially disk-shaped silicon steel plates 511a in the direction of the axis of the rotor 51. In each of these silicon steel plates 511a, as illustrated in FIG. 12B, there are formed the following holes: an insertion hole 511b for installing the rotating shaft 53 in the axial center of the rotor 51; housing holes 511c for installing a conductor bar 512 formed of aluminum, arranged in the peripheral portion of the rotor 51 at predetermined angular intervals; and the like. Each of the housing holes 511c is provided with a cutout 511d, and thus the housing holes 511c are open on the outer radius side. When these silicon steel plates 511a are laminated and the iron core 511 is formed, the insertion hole 511b, housing holes 511c, and cutouts 511d penetrate the iron core 511 in the axial direction.

At both ends of the rotor 51 in the axial direction, there are provided a pair of end rings 513. The end rings 513 are respectively formed substantially in disk shape and have substantially the same diameter as that of the silicon steel plates 511a. The end rings, together with the iron core 511, form the substantially columnar rotor 51. That is, the rotor 51 is so formed that the iron core 511 is sandwiched between the pair of end rings 513. In the axial center of each end ring 513, as illustrated in FIG. 12B, there is formed an insertion hole 513a so that it communicates with the above insertion hole 511b and the rotating shaft 53 is passed through the rotor 51 in the axial center. In the peripheral portion of each end ring 513, there are formed bond holes 513b for bonding the conductor bars 512, respectively in correspondence with the above housing holes 511c. Aluminum casting material is cast so that the housing holes 511c and the bond holes 513b are completely filled, and the cage-like conductor bars 512 are thereby formed so that the iron core 511 is encircled with them.

Next, an operation of this electric induction motor is described hereinafter. Alternating voltage is applied to the exciting coil, and a rotating magnetic field corresponding to this applied voltage is thereby generated. Thus, an induced current (eddy current) is passed through the rotor 51 (specifically, the conductor bars 512) in correspondence with the rotating magnetic field. The induced current and the rotating magnetic field produces rotating force, and the rotor 51 is rotated out of synchronization with the synchronous speed (magnetic field speed) corresponding to the frequency of the field application voltage.

When such a turbocharger with electric motor is continuously used, its output characteristics (especially, torque characteristics) are degraded with time (cumulatively) and an intended output is not obtained. The inventors consider that a cause of degradation in output lies in the use environment of the turbocharger with electric motor.

Such a turbocharger with electric motor is so constructed that a turbine provided in an engine exhaust system is driven by exhaust gas. Therefore, the turbocharger body and an assist electric motor are usually used in a high-temperature environment. In a diesel engine for automobiles, for example, the exhaust temperature is about 700° C., and a turbocharger with electric motor is used in this high-temperature environment. However, conventional ordinary turbochargers with electric motor are not always provided with heat resistance sufficient to endure such a severe use environment for a long time. If such a device is used in this high-temperature environment for a long time, it is exposed long to high temperature, and there is a possibility that an intended output is not obtained. For example, when the turbocharger with electric motor using the electric induction motor illustrated in FIGS. 12A to 12C as an assist electric motor is used in the high-temperature environment for a long time, the contact resistance is slightly increased in areas where the conductor bars 512 are cast-bonded. This lowers the induced current (eddy current) passed through the rotor 51 (specifically, the conductor bars 512), and as a result, the output (especially, torque) of the electric induction motor is degraded (lowered) not a little.

### SUMMARY OF THE INVENTION

It is an object of the invention to provide a controller for turbochargers with electric motor wherein even when a turbocharger with electric motor is used in a high-temperature environment, degradation in output arising from this use environment is suppressed and stable operation of the turbocharger can be continuously achieved for a long time.

According to an aspect of the invention, a controller includes a differential computation unit that compares a target power value for the assist electric motor equivalent to a control target value with a value of power actually supplied to the assist electric motor and computes the differential between them. The controller further includes a torque error compensation unit that compensates a torque error of the assist electric motor arising from the differential based on the differential computed by the differential computation unit.

Correction of revolution speed is also carried out in ordinary electric motors. With respect to the torque of electric motors, however, the actual situation is that any useful correcting method has not been established. There is basically certain correlation between a power value and torque. A torque error of the assist electric motor is appropriately compensated by adopting such a construction in which based on the differential between a target power value for the assist electric motor and an actual power value, correction is carried out (for example, so as to reduce or completely eliminate the differential between them). With this construction, even when the contact resistance is increased in a conductor bonded area, the output degraded due to this increase can be early corrected by the torque error compensation unit. Also, a period in which an output error is contained can be shortened. Specifically, even when a turbocharger with electric motor is used in a high-temperature environment, degradation in output (usually, reduction in output) due to its environment can be suppressed, and stable operation of the turbocharger (operation with a small output error) can be continuously achieved for a long time.

The differential computation unit may perform the following operation. That is, target power values and actual power values or degrees of difference obtained by multiple times of acquisition and computation are averaged, and an ultimate differential is obtained based on this average. With this, the differential between a target power value for an assist electric motor and an actual power value can be computed with a higher level of accuracy.

### BRIEF DESCRIPTION OF THE DRAWINGS

FIG. 1 is a schematic diagram illustrating the overview of an engine control system to which a controller for turbochargers with electric motor in an embodiment is applied;

FIG. 2 is a cross sectional view illustrating an internal structure of a turbocharger with electric motor;

FIG. 3 is a block diagram mainly illustrating a configuration of a motor ECU;

FIG. 4 is a block diagram illustrating a computation of a target field speed and a target voltage in a motor ECU;

FIG. 5 is a flowchart illustrating a procedure for torque correction;

FIG. 6 is a flowchart illustrating a procedure for torque correction;

FIG. 7 is a flowchart illustrating a procedure for torque correction;

FIG. 8 is a block diagram illustrating a correction of torque;

FIG. 9 is a timing diagram illustrating the progression of control parameters during torque correction;

FIG. 10 is a block diagram illustrating a correction of torque in the other embodiment;

FIG. 11 is a graph schematically indicating the relation between torque and slip (slip ratio S) observed when the voltage value of an assist electric motor is made constant;

FIG. 12A is a perspective view illustrating the general structure of a cage rotor used in an assist electric motor;

FIG. 12B is a sectional view schematically illustrating the axial plane structure of the iron core of the rotor; and

FIG. 12C is a chart illustrating an end ring used in the rotor as viewed from the axial direction.

### DETAILED DESCRIPTION OF EMBODIMENTS

An embodiment of the present invention will be described hereinafter. In this embodiment, a controller is mounted in a control system for a diesel engine (internal combustion engine).

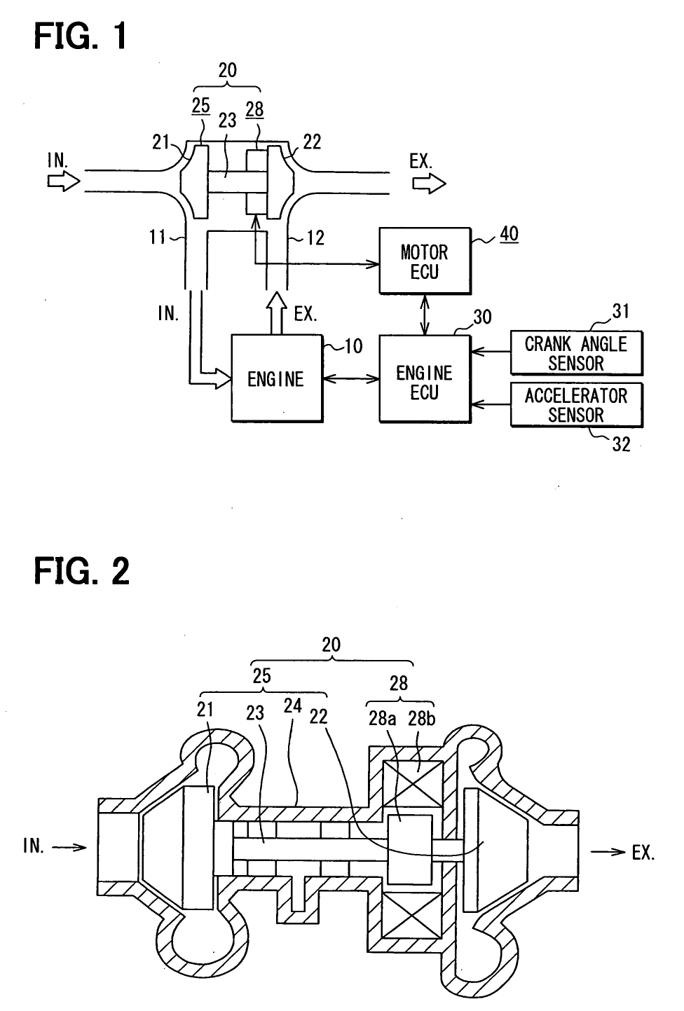

First, detailed description will be given to the configuration of the vehicle control system with reference to FIG. 1 to FIG. 4.

As illustrated in FIG. 1, the vehicle control system is intended to control a four-cylinder reciprocal diesel engine 10 equipped with a common rail fuel injection device. It is so constructed as to control various actuators by an engine ECU 30, a motor ECU 40, and the like as electronic control units. These actuators include the assist electric motor (assist motor) 28 provided to a turbocharger body 25. The vehicle, not shown, is provided with various sensors for vehicle control. A crank angle sensor 31 outputs a crank angle signal (an electrical signal) at predetermined crank angular intervals (e.g., at intervals of 30° C.A) so that engine revolution speed as well as a crank position (rotation angle position) can be detected. An accelerator sensor 32 detects the amount of accelerator pedal operation by the driver (accelerator opening) and outputs the result of detection as an electrical signal.

In this system, the motor ECU 40 controls mainly an electrically assisted turbocharger 20 provided between the intake pipe 11 and exhaust pipe 12 of an engine 10. The electrically assisted turbocharger 20 includes the turbocharger body 25 that carries out supercharging in an intake system, utilizing exhaust power; and the assist electric motor 28 that is installed in the turbocharger body 25 and assists (helps) the body 25 in driving. The turbocharger body 25 includes a compressor (compressor impeller) 21 provided in the intake pipe 11, and a turbine (turbine wheel) 22 provided in the exhaust pipe 12. The compressor 21 and the turbine 22 are coupled with each other through a shaft 23. That is, the turbine 22 is rotated by exhaust gas flowing through the exhaust pipe 12, and its turning force is transmitted to the compressor 21 through the shaft 23. The air flowing through the intake pipe 11 is compressed by this compressor 21, and supercharging is thereby carried out. At this time, the supercharged air is cooled by an inter-cooler (not shown) disposed downstream of the compressor 21, and the charging efficiency of the intake air is thereby further enhanced.

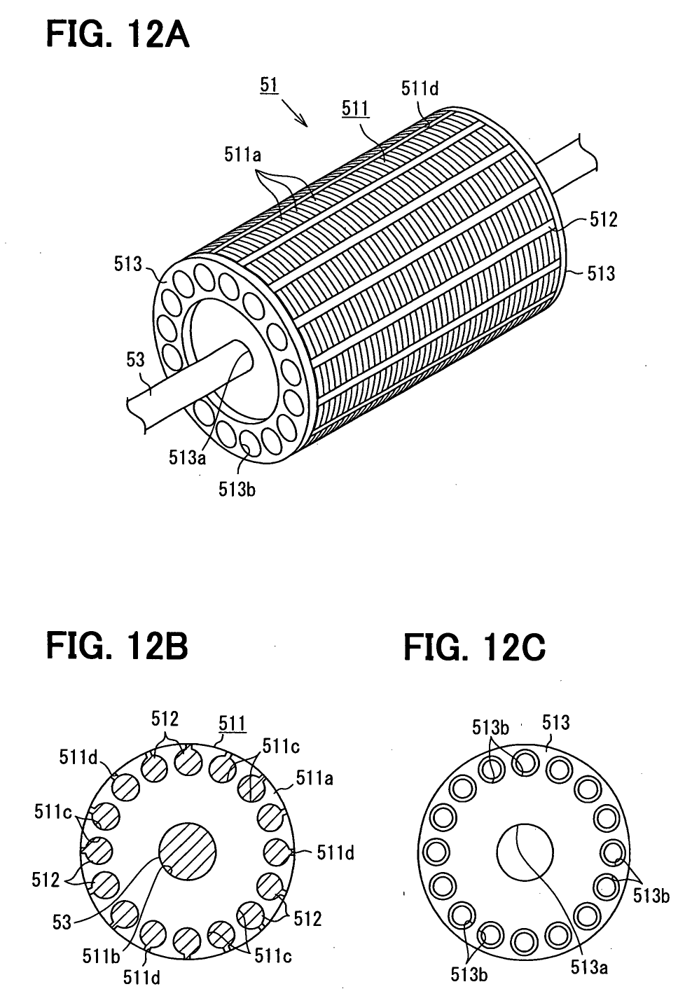

More detailed description will be given to the structure of the electrically assisted turbocharger 20 with reference to FIG. 2. FIG. 2 is an internal side view illustrating the internal structure of the electrically assisted turbocharger 20. The above assist electric motor 28 used in this embodiment is an alternating current-driven electric induction motor (one of so-called AC motors) using a cage rotor. Its structure is the same as the structure of the electric motor illustrated in FIGS. 12A to 12C. Its general structure will be described here, and the detailed description of the structure will be omitted.

As illustrated in FIG. 2, the electrically assisted turbocharger 20 has a housing 24 which accommodates the compressor 21, the turbine 22, the shaft 23, and assist electric motor 28 therein. The assist electric motor 28 includes a cage rotor 28a on the shaft 23, and an exciting coil 28b around the rotor 28a. In response to the application of alternating-current voltage (six-phase in this example) to the exciting coil 28b, the turbocharger body 25 is assisted (helped) in performing the above supercharging operation.

The engine ECU 30 and the motor ECU 40 independently perform the vehicle control in this system. Provided with a publicly known microcomputer (not shown), these ECUs 30, 40 operate various actuators in a desired mode based on the operating state of the engine 10 and detection values from various sensors that detect a user's request. The microcomputers built in the ECUs 30, 40 are so constructed that they include various arithmetic units and storage units including: CPU (basic processor) that carries out varied computation; RAM (Random Access Memory) as a main memory that temporarily stores data in process of computation, a result of computation, and the like; ROM (Read Only Memory) as a program memory; EEPROM (Electrically Erasable Programmable Read Only Memory) as a memory for data storage; and the like. In the ROM, there are stored beforehand various programs, control maps, and the like related to vehicle control. In the memory (EEPROM) for data storage, there are stored beforehand varied control data and the like, including the design data of the engine 10.

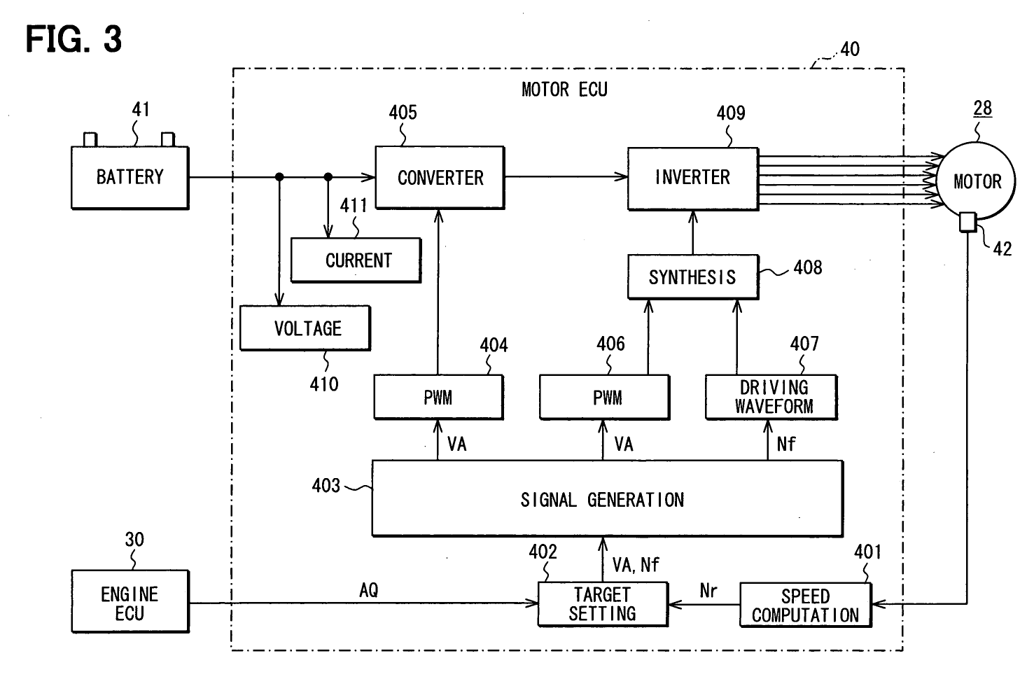

Hereafter, more detailed description will be given to the configuration of the motor ECU 40 with reference to FIG. 3.

As illustrated in FIG. 3, the motor ECU 40 is constructed of various components 401 to 411. It is supplied with power from an in-vehicle battery 41 as a power supply that supplies power with a voltage of, for example, 12V and controls energization of the assist electric motor 28 (specifically, six-phase exciting coil 28b) based on the following: a requested assist amount acquired from the engine ECU 30 from time to time; the revolution speed of the turbocharger 20 (equivalent to the revolution speed of the electric motor 28) sequentially detected. The requested assist amount (target output AQ) is equivalent to the amount of driving of the assist electric motor 28 required according to the operating state of the engine on each occasion. It is computed at the engine ECU 30 based on the operating state of the engine 10. (The operating state of the engine includes, for example, engine revolution speed, amount of accelerator operation, requested engine torque, etc.) The revolution speed (turbo revolution speed Nr) of the turbocharger 20 is computed at a revolution speed computation unit 401 based a pickup signal from a revolution speed detection sensor 42 placed in the compressor 21. This signal is a signal indicating the revolution speed of the shaft 23.

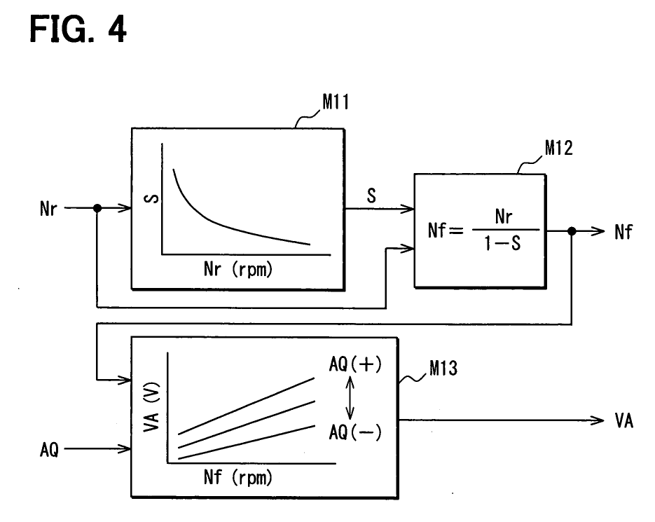

In the motor ECU 40, a target setting unit 402 respectively acquires a target output AQ and a turbo revolution speed Nr from the engine ECU 30 and the revolution speed computation unit 401; and then it computes the most appropriate target field speed Nf and target voltage VA based on these parameters. The target field speed Nf is the frequency of alternating-current voltage to be applied to the exciting coil 28b. The target voltage VA is the magnitude of alternating-current voltage to be applied to the exciting coil 28b. FIG. 4 illustrates in detail the way this computation is carried out.

As illustrated in FIG. 4, the target setting unit 402 is so constructed that it is provided with maps M11, M13 and a relational expression M12 for computing target field speed Nf and target voltage VA. In the map M11, the most appropriate slip ratio S (slip) of the assist electric motor 28 is uniquely defined with respect to turbo revolution speed Nr. The map M11 shows that as the turbo revolution speed Nr increases, the slip ratio S as a compatible value corresponding thereto decreases. In the relational expression M12, the most appropriate target field speed Nf is uniquely defined with respect to turbo revolution speed Nr and slip ratio S. This embodiment uses a relational expression expressed as “Nf=Nr/(1−S).” In the target setting unit 402, the following processing is carried out: a slip ratio S corresponding to a turbo revolution speed Nr acquired from the revolution speed computation unit 401 is determined from the map M11; and the most appropriate target field speed Nf corresponding to the turbo revolution speed Nr and slip ratio S is computed by the relational expression M12. In the map M13, the most appropriate target voltage VA is uniquely defined with respect to target field speed Nf and target output AQ. Incidentally, in the map M13, as the target field speed Nf increases and the target output AQ increases, the target voltage VA as a compatible value corresponding thereto increases. In the target setting unit 402, the most appropriate target voltage VA corresponding to a target field speed Nf computed by the relational expression M12 and a target output AQ acquired from the engine ECU 30 is determined based on this map M13.

In the target setting unit 402, as mentioned above, the most appropriate target field speed Nf and target voltage VA corresponding to the above target output AQ and turbo revolution speed Nr are computed based on the maps M11, M13 and the relational expression M12. The target field speed Nf and target voltage VA computed at the target setting unit 402 are inputted to a signal generation unit 403 (FIG. 3). The signal generation unit 403 supplies an appropriate electrical signal to PWM generation units 404, 406 and a driving waveform generation unit 407, and thereby generates a desired waveform through these waveform generation units 404, 406, 407.

The PWM generation unit 404 operates as follows: based on an electrical signal (signal corresponding to the target voltage VA) supplied from the signal generation unit 403, it generates a rectangular waveform of a duty ratio corresponding to that signal. Then, it carries out PWM (Pulse Width Modulation) control on a converter unit 405. In this motor ECU 40, the output voltage value (the magnitude of voltage) of the converter unit 405 is controlled through this PWM generation unit 404. The converter unit 405 converts a direct current (DC) into a direct current having a different voltage value, and functions as a so-called DC-DC converter. Specifically, the converter unit 405 is so constructed that voltages boosted in individual phases by a three-phase chopper-type booster circuit are charged (stored) in a capacitor. The booster circuit is constructed of a choke coil supplied with power supply voltage (e.g., 12V) from the battery 41, and an FET (Field Effect Transistor) for controlling whether to energize the choke coil. In this converter unit 405, a rectangular waveform from the PWM generation unit 404 is applied to the gate of the FET as a switching element. The output voltage value of the converter unit 405 is thereby controlled (e.g., controlled to 30V) based on the duty ratio (energization time) of the same waveform. The duty ratio is defined as the ratio of a duration Dt of logical high level to a fundamental period DT, or (Dt/DT)×100(%).

The PWM generation unit 406 operates as follows: based on an electrical signal (signal corresponding to the target voltage VA) supplied from the signal generation unit 403, it generates a rectangular waveform of the duty ratio corresponding to that signal. The driving waveform generation unit 407 operates as follows: based on an electrical signal (signal corresponding to the target field speed Nf) supplied from the signal generation unit 403, it generates a driving waveform (rectangular waveform) of the frequency corresponding to that signal. This frequency is equivalent to the frequency of alternating-current voltage to be applied to the exciting coil 28b. A synthesis unit 408 is constructed of, for example, an AND circuit, and synthesizes waveforms generated by the waveform generation units 406, 407 and supplies the result of synthesis to an inverter unit 409.

The inverter unit 409 is PWM (Pulse Width Modulation) controlled by the PWM generation unit 406, and thereby makes the output voltage value (the magnitude of voltage) variable. Further, it makes the output frequency variable based on the driving waveform from the driving waveform generation unit 407. That is, the inverter unit 409 is so constructed that both the frequency and the voltage value of a direct current supplied from the converter unit 405 can be varied therein. Specific description will be given. The inverter unit 409 is constructed of 12 FETs that control the state (the polarity of voltage, voltage value, etc.) of energization of the six-phase exciting coil 28b of the assist electric motor 28. A rectangular waveform from the PWM generation unit 406 and the driving waveform generation unit 407 is applied to the gates of these FETs as switching elements. As a result, the output voltage value and the output frequency are controlled based on the waveform. Thus, the six-phase exciting coil 28b is supplied with voltage (current) of which phase is shifted on a 60°-by-60° basis.

The motor ECU 40 has a voltage detection unit 410 and a current detection unit 411 for separately detecting the magnitudes of voltage and current supplied from the battery 41. The voltage detection unit 410 and the current detection unit 411 are placed in the power supply line to the motor ECU 40 and detect the magnitudes of voltage and current supplied to the converter unit 405. The voltage detection unit 410 directly detects voltage applied from the battery 41; therefore, a voltage substantially equal to the power supply voltage (e.g., 12V) of the battery 41 is constantly detected. However, as the magnitude of power (=voltage×current) detected through the cooperation between the voltage detection unit 410 and the current detection unit 411, a value equal to the power supplied to the assist electric motor 28 (the amount of power supply to the assist electric motor 28) is obtained.

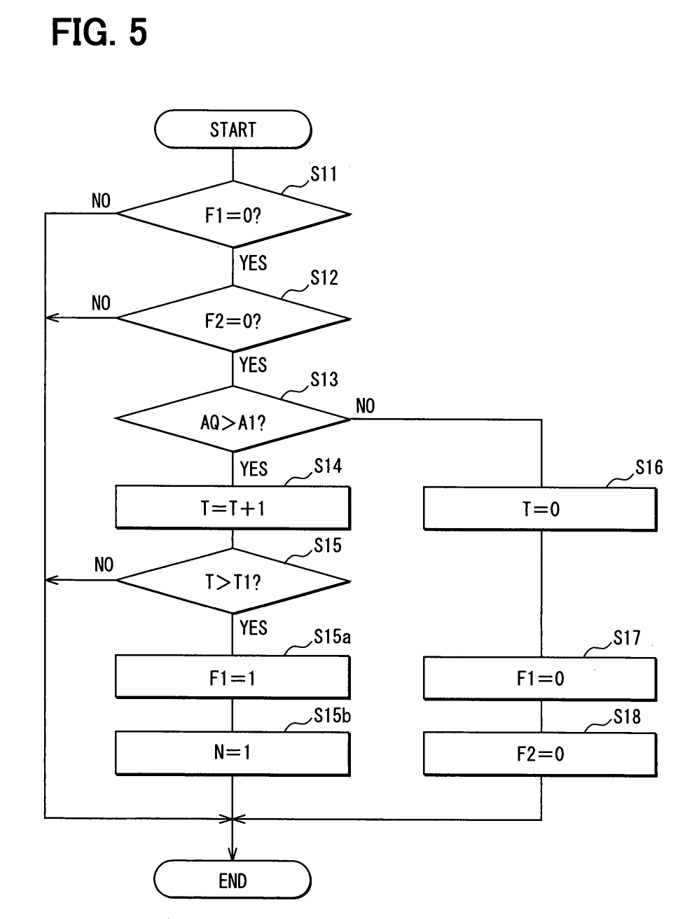

Up to this point, description has been given to the configuration of the vehicle control system in this embodiment. Next, description will be given to the operation of this system on the processing by the motor ECU 40 with reference to FIG. 5 to FIG. 9.

The engine response is improved by the following measure also in this system. In transition from a low rotation range to a high rotation range (acceleration), for example, assist power is imparted to the rotating shaft (shaft 23) of the turbocharger body 25 by the assist electric motor 28. Specifically, based on a requested assist amount (target output AQ) from the engine ECU 30, the motor ECU 40 controls driving of the assist electric motor 28 so that this target output AQ will be achieved.

However, when the electrically assisted turbocharger 20 is continuously used, as mentioned above, the output characteristics (especially, torque characteristics) are degraded (lowered) with time (cumulatively) due to age deterioration in the assist electric motor 28. In this embodiment, the following is accomplished by correcting the torque of the assist electric motor 28 (compensating any torque error) with the motor ECU 40: the degradation in output is suppressed, and stable operation of the electrically assisted turbocharger 20 (operation with a small output error) is achieved for a long time.

FIG. 5 to FIG. 7 are flowcharts illustrating procedures for torque correction carried out by the motor ECU 40 in this embodiment. Sequences of processing illustrated in these drawings are basically sequentially carried out at predetermined crank angular intervals or time intervals by a program, stored in the ROM, being executed at the motor ECU 40. The values of various parameters used in the processing illustrated in these drawings are stored in, for example, a storage device such as the RAM and the EEPROM built in the motor ECU 40 from time to time, and are updated as required.

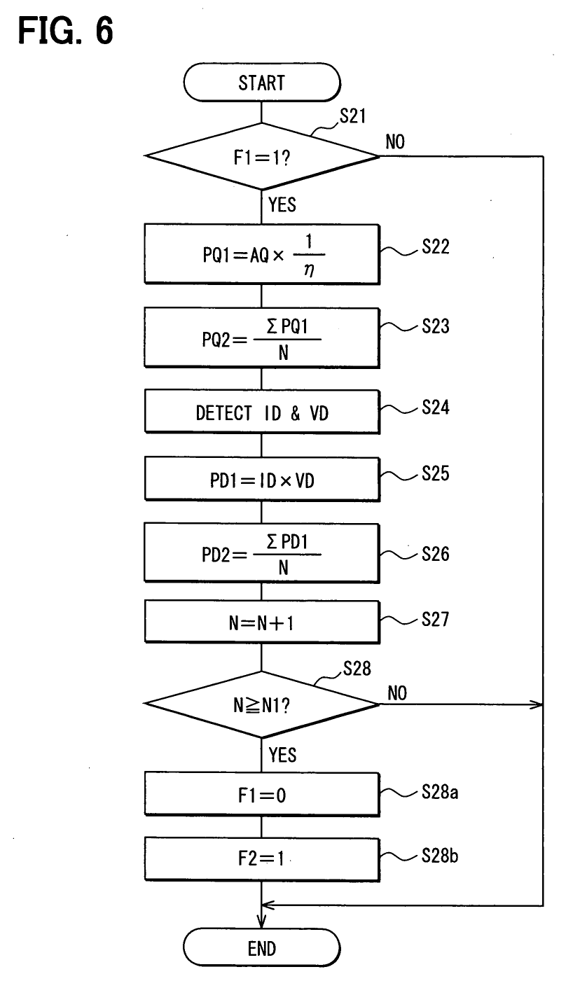

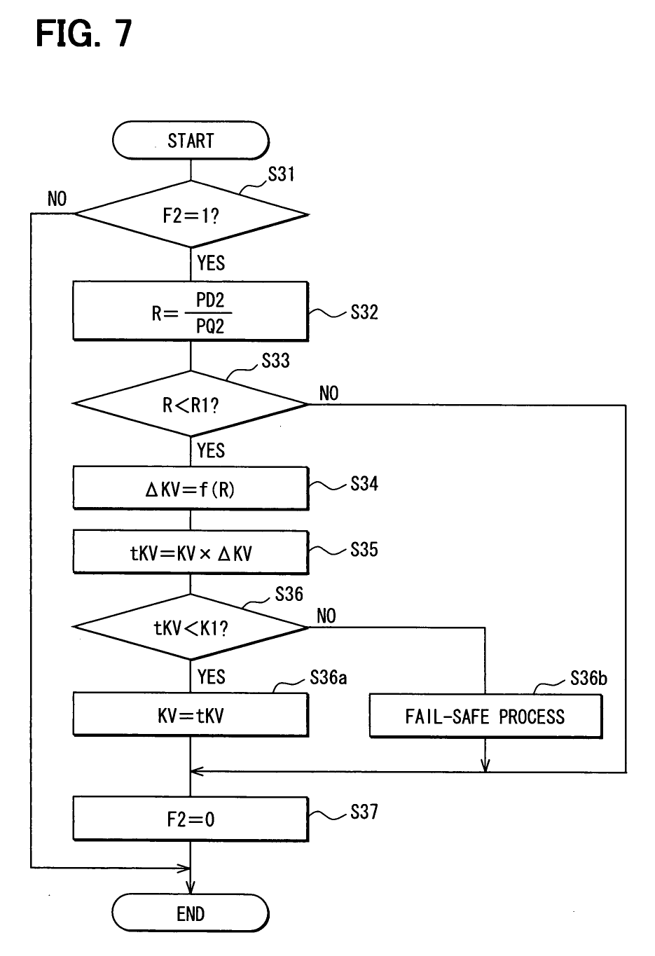

As illustrated in FIG. 5 to FIG. 7, it is determined at the first step whether or not an execution condition is met. More specific description will be given. In the processing in FIG. 5, when both flags F1 and F2 are set to “0”, the execution condition is established. In the processing in FIG. 6, when the flag F1 is set to “1”, the execution condition is established. In the processing in FIG. 7, when the flag F2 is set to “1”, the execution condition is established. It is repeatedly determined whether or not these execution conditions are met until they are met. When these conditions are met, the flow proceeds to the next step. In this embodiment, the initial values of the flags F1, F2 are set to “0.” In the beginning, therefore, only the processing in FIG. 5 proceeds. Hereafter, description will be given to the processing illustrated in FIG. 5.

In this sequence of processing, as illustrated in FIG. 5, it is determined at Steps S11 and S12 whether or not the above-mentioned execution condition is met. When this condition is met, the flow proceeds to Step S13. At Step S13, the target output AQ is compared with a threshold value A1 (e.g., a predetermined fixed value or variable value) to determine whether or not the target output AQ is greater than the threshold value A1 (AQ>A1). When it is determined at Step S13 that the relation expressed as “AQ>A1” does not hold, a timer count T and the flags F1, F2 are subsequently reset (set to “0”) at Steps S16 to S18. The timer count T indicates a time that has lapsed after the relation expressed as “AQ>A1” held. As mentioned above, the assist flag F1 and the power computation flag F2 pertain to the respective execution conditions in the processing illustrated in FIG. 5 to FIG. 7.

When it is determined at Step S13 that the relation expressed as “AQ>A1” holds, subsequently, the timer count T is incremented (T=T+1) at Step S14. At Step S15, subsequently, the timer count T is compared with a threshold value T1 (e.g., a predetermined fixed value or variable value) to determine whether or not the timer count T is greater than the threshold value T1 (T>T1). When it is determined at Step S15 that the relation expressed as “T>T1” does not hold, this sequence of processing illustrated in FIG. 5 is terminated. Then, the processing of Steps S11 to S15 is repeatedly carried out until the relation expressed as “T>T1” holds.

When it is determined at Step S15 that the relation expressed as “T>T1” holds, subsequently, the assist flag F1 and a counter N are set to “1” at Steps S15a and S15b. That is, when the state of “AQ>A1” is constantly (stably) maintained during a period equivalent to the threshold value T1, the flag F1 and the counter N are set to “1.” Thus, the execution condition for the processing illustrated in FIG. 6 is met, and further the execution condition for the processing illustrated in FIG. 5 is not met any more. Description will be given to the processing illustrated in FIG. 6.

In this sequence of processing, as illustrated in FIG. 6, it is determined at Step S21 whether or not the above-mentioned execution condition is met. When this condition is met, the flow proceeds to Step S22. At Step S22, a target power PQ1 is computed based on the target output AQ. Specifically, it is computed based on, for example, a relational expression expressed as “PQ1=AQ×1/η” (η: the efficiency of the assist electric motor 28). At Step S23, subsequently, this computed value (target power PQ1), together with computed values obtained by N times of computation in the past, is averaged (“PQ2=ΣPQ1/N”) to obtain an average target power PQ2. When N=1, data is insufficient to obtain an average, and this averaging processing (Step S23) is substantially omitted.

At Step S24, subsequently, the magnitude of voltage supplied (inputted) from the battery 41 to the motor ECU 40 (actual input voltage VD) is detected with the voltage detection unit 410, and the magnitude of current supplied (inputted) from the battery 41 to the motor ECU 40 (actual input current ID) is detected with the current detection unit 411 (FIG. 3). At Step S25, subsequently, the power actually supplied (inputted) to the assist electric motor 28 (actual input power PD1) is computed based on the actual input voltage VD and the actual input current ID. Specifically, it is computed based on, for example, a relational expression expressed as “PD1=ID×VD.” At Step S26, subsequently, this computed value (actual input power PD1), together with computed values obtained by N times of computation in the past, is averaged (“PD2=ΣPD1/N”) to obtain an average actual input power PD2. When N=1, data is insufficient to obtain an average, and this averaging processing (Step S26) is substantially omitted.

After the average actual input power PD2 is computed, as mentioned above, subsequently, the counter N is incremented (N=N+1) at Step S27. At Step S28, the value of the counter N is compared with a threshold value N1 (e.g., a predetermined fixed value or variable value) to determine whether or not the value of the counter N is equal to or higher than the threshold value N1 (N≧N1). When it is determined at Step S28 that the relation expressed as “N≧N1” does not hold, this sequence of processing illustrated in FIG. 6 is terminated. Then, the processing of Steps S21 to S28 is repeatedly carried out until the relation expressed as “N>N1” holds.

When it is determined at Step S28 that the relation expressed as “N≧N1” holds, subsequently, the assist flag F1 is set to “0” at Step S28 and the power computation flag F2 is set to “1” at S28b. That is, when the above average target power PQ2 and average actual input power PD2 could be obtained as the average values of, respectively, “N1−1” pieces of target power PQ1 and actual input power PD1, obtained by “N1−1” times (e.g., three times) of acquisition and computation, the above processing is carried out with respect to the flags F1 and F2. Thus, the execution condition for the processing illustrated in FIG. 7 is met, and further the execution condition for the processing illustrated in FIG. 6 is not met any more. Description will be given to the processing illustrated in FIG. 7.

In this sequence of processing, as illustrated in FIG. 7, it is determined at Step S31 whether or not the above-mentioned execution condition is met. When this condition is met, the flow proceeds to Step S32.

At Step S32, the ratio R between the average target power PQ2 and the average actual input power PD2 is computed based on, for example, a relational expression expressed as “R=PD2/PQ2.” This ratio R is equivalent to the differential between a target power value and an actual power value of the assist electric motor 28. Without deterioration, the ratio takes a value of “1.” The more deterioration progresses, the more the value is reduced.

At Step S33, subsequently, this ratio R is compared with a threshold value R1 (e.g., a predetermined fixed value or variable value) to determine whether or not the ratio R is smaller than the threshold value R1 (e.g., a fixed value “0.9”) (R<R1). When it is determined at Step S33 that the relation expressed as “R<R1” does not hold, the torque error is small and torque correction (compensation of torque error) is unnecessary. Therefore, at Step S37, subsequently, the power computation flag F2 is set to “0,” and this sequence of processing illustrated in FIG. 7 is terminated. Thus, the execution condition for the processing illustrated in FIG. 5 is met, and the execution condition for the processing illustrated in FIG. 7 is not met any more. Therefore, the processing illustrated in FIG. 7 is substantially stopped, and the processing illustrated in FIG. 5 is carried out.

When it is determined at Step S33 that the relation expressed as “R<R1” holds, torque correction is required and computation of a correction coefficient is started. More specific description will be given. At Step S34, a variation ΔKV of correction coefficient is computed based on a function f(R) of the ratio R. A power value is in proportion to the square of a voltage value (Ohm's law); therefore, this variation ΔKV is computed based on, for example, a relational expression expressed as “ΔKV=√(1/R).” Without deterioration, the variation ΔKV is “1” and increased as deterioration progresses.

At Step S35, subsequently, a temporary correction coefficient tKV is computed based on the current correction coefficient KV (“1” without correction) and the above variation ΔKV. Specifically, the temporary correction coefficient tKV is computed based on, for example, a relational expression expressed as “tKV=KV×ΔKV.” The correction coefficient KV is a coefficient for compensating a cumulative torque error (for canceling out an error) due to degradation in torque with time, and indicates a cumulative amount of compensation in a manner. This correction coefficient KV is sequentially updated (Step S36a).

At Step S36, subsequently, the temporary correction coefficient tKV computed at Step S35 is compared with a threshold value K1 (e.g., a predetermined fixed value or variable value) to determine whether or not the temporary correction coefficient tKV is smaller than the threshold value K1 (tKV<K1). When it is determined at Step S36 that the relation expressed as “tKV<K1” does not hold, the degree of deterioration in the assist electric motor 28 has become too serious to cope with by correction. In this case, subsequently, so-called fail-safe processing is carried out at Step S36b. Specifically, the driver, the engine ECU 30, or the like is notified of the presence of an anomaly by an appropriate notifying device, such as a warning lamp, a warning buzzer, or an abnormal signal generator. This notification is carried out by turning on a warning lamp, sounding a buzzer, or transmitting an abnormal signal such as an error message. Thus, each device that received an abnormal signal can shift to operation for anomalies, and the driver or the like can replace or repair the assist electric motor 28 or take other like remedial measures as required.

After this fail-safe processing is carried out, the flow proceeds to Step S37 without updating the correction coefficient KV. Thus, similarly with the foregoing, the processing illustrated in FIG. 7 is substantially stopped, and the processing illustrated in FIG. 5 is started.

When it is determined at Step S36 that the relation expressed as “tKV>K1” holds, substantially, the correction coefficient KV is updated based on the temporary correction coefficient tKV at Step S36a (KV=tKV). At Step S37, subsequently, the power computation flag F2 is set to “0,” and then this sequence of processing illustrated in FIG. 7 is terminated. Thus, similarly with the foregoing, the processing illustrated in FIG. 7 is substantially stopped, and the processing illustrated in FIG. 5 is started.

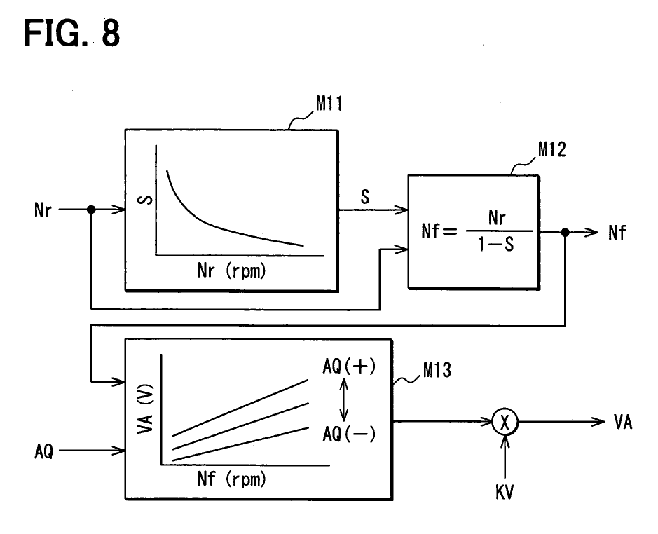

In this embodiment, the correction coefficient KV is sequentially updated, as mentioned above. Then, as illustrated in FIG. 8 (corresponding to FIG. 4), the target voltage VA is corrected (multiplied by the correction coefficient KV) so as to correct the torque of the assist electric motor 28 based on this correction coefficient KV. The target voltage VA is one of signals outputted from the target setting unit 402 (FIG. 3) (inputted to the signal generation unit 403, in other words). The target voltage VA 1b indicates the magnitude of alternating voltage applied to the exciting coil 28b. When the target voltage VA is corrected to an appropriate value, an output error, accordingly, a torque error is appropriately compensated. Stable operation of the electrically assisted turbocharger 20 (operation with a small output error) is continuously achieved for a long time by this correction.

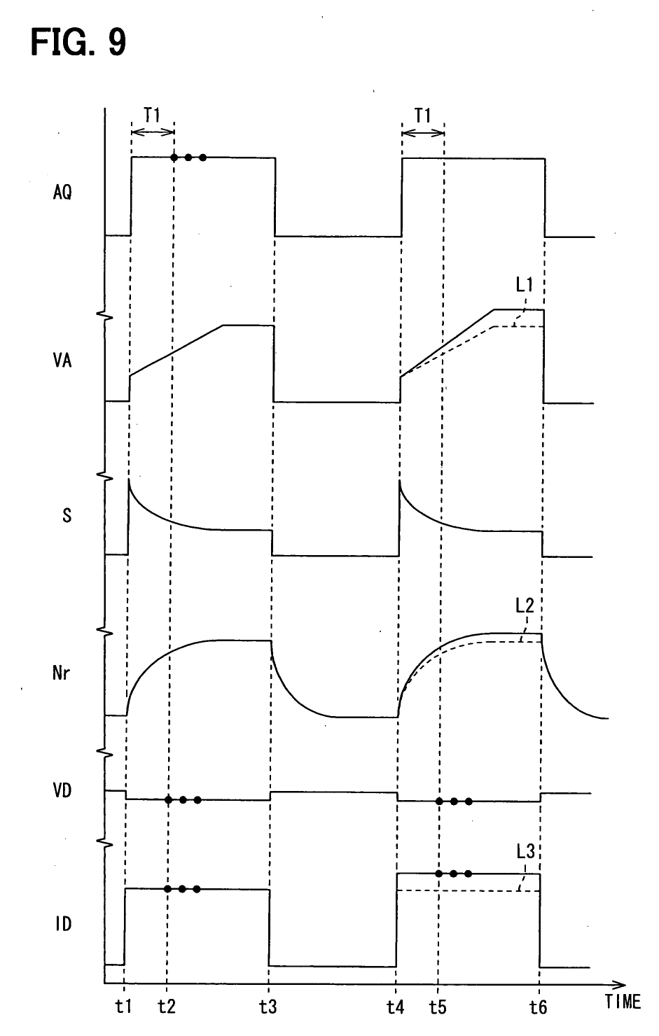

FIG. 9 is a timing diagram illustrating the progression of various control parameters observed when the processing of FIG. 5 to FIG. 7 is carried out. The control parameters are the target output AQ, the target voltage VA, the slip ratio S, the turbo revolution speed Nr, the actual input voltage VD, and the actual input current ID.

More specific description will be given. When an assist request is sent from the engine ECU 30 at time t1 in FIG. 9, the target output AQ exceeds the threshold value A1. Then, it is determined at Step S13 (FIG. 5) that the relation expressed as “AQ>A1” holds. When the state of “AQ>A1” is constantly (stably) maintained during a period corresponding to the threshold value T1, the sequence of processing illustrated in FIG. 6 is carried out at time t2. At Step S28 (FIG. 6), the average target power PQ2 and the average actual input power PD2 are obtained by “N1−1” times (e.g., three times) of acquisition and computation. Based on these values, the correction coefficient KV is computed and updated through the processing illustrated in FIG. 7, and then the assist by the assist electric motor 28 is stopped at time t3.

Thus, when an assist request is thereafter sent from the engine ECU 30 again at time t4, the target voltage VA corrected with the correction coefficient KV (solid line in FIG. 9) is supplied to the signal generation unit 403 (FIG. 3). The broken line L1 represents the value (target voltage VA) before correction.

As indicated by the solid lines indicating the control parameters VD and ID in FIG. 9, the correction coefficient KV is also incorporated into the following: the amount of power supply to the assist electric motor 28 controlled based on an electrical signal from the signal generation unit 403. That is, the amount of power supply is increased by an amount equivalent to reduction due to deterioration (increase in contact resistance) in a conductor bonded area in the assist electric motor 28. In this embodiment, the voltage applied from the battery 41 is directly detected. Therefore, the actual input voltage VD as a detection value is substantially constant, and change in power value is detected mainly as change in actual input current ID. The broken line L3 indicating the control parameter ID in FIG. 9 also indicates a current value before correction.

As indicated by the solid line indicating the control parameter Nr in FIG. 9, when the amount of power supply to the assist electric motor 28 is corrected, the turbo revolution speed Nr is also corrected. Then, the torque of the assist electric motor 28 is also appropriately corrected in a mode in accordance with this turbo revolution speed Nr. The turbo revolution speed Nr is computed at the revolution speed computation unit 401 (FIG. 3). The broken line L2 indicating the control parameter Nr in FIG. 9 also indicates a value (turbo revolution speed Nr) before correction.

The correction coefficient KV is further updated similarly with the foregoing during a period from time t4 to time t3 corresponding to the period from time t1 to time t3. This update is carried out based on the differential (ratio R) between the target power value (average target power PQ2) and the actual power value (average actual input power PD2) at that time (after correction in the period from time t1 to time t3). Thus, the correction coefficient KV is basically updated as required each time assist is performed. In case of long-time assist, however, it is updated multiple times for one time of assist execution.

According to this embodiment described above, the following advantages are obtained.

(1) A electrically assisted turbocharger 20 includes: a turbocharger body 25 that carries out supercharging in an engine air intake system by a compressor 21 in interlock with a turbine 22 provided in an engine exhaust system when the turbine 22 is driven by an exhaust stream; and an assist electric motor 28 that is installed in the turbocharger body 25 and assists (helps) the turbocharger body 25 in driving. A device (motor ECU 40) is used to control this electrically assisted turbocharger 20 and controls the operation of the assist electric motor 28. The motor ECU is provided with the following programs: a program for comparing a target power value (average target power PQ2) of the assist electric motor 28, equivalent to a control target value, with an actual power value (average actual input power PD2) indicating power actually supplied to the assist electric motor 28, and computing the differential between them; and a program for compensating a torque error of the assist electric motor 28 arising from the differential (updating a correction coefficient KV) based on the differential (ratio R) computed at Step S32. This makes it possible to suppress degradation in the output (reduction in the output) of the electrically assisted turbocharger 20 and continuously achieve stable operation of the turbocharger 20 (operation with a small output error) for a long time.

(2) The motor ECU is provided with a program (Steps S22 to S26 in FIG. 6) for carrying out the following processing: target power values and actual power values obtained by multiple times (e.g., three times) of acquisition and computation are averaged, and an ultimate differential (ratio R) is obtained based on this average. This makes it possible to compute the differential (ratio R) between a target power value and an actual power value of the assist electric motor 28 with a higher level of accuracy.

(3) At Step S32, the ratio R between a target power value (average target power PQ2) and an actual power value (average actual input power PD2) is computed. This makes it possible to simultaneously accomplish both the simplicity and the accuracy of computation.

(4) At Step S36a, the amount of power supply to the assist electric motor 28 is corrected (the correction coefficient KV related to the target voltage VA is updated). This makes it possible to easily and appropriately carry out such correction as to reduce or completely eliminate the differential between a target power value (average target power PQ2) and an actual power value (average actual input power PD2).

(5) The assist electric motor 28 is constructed as an electric induction motor that implements the following: alternating-current voltage is applied to the magnetic field (exciting coil 28b) as a stator; in response thereto, force is produced by the action of a rotating magnetic field corresponding to that field application voltage and an induced current (eddy current) passed through a rotor (cage rotor 28a) in correspondence with this rotating magnetic field; and the rotor is rotated out of synchronization with the synchronous speed (field speed) corresponding to the frequency of the field application voltage. This makes it possible to ensure sufficient resistance to centrifugal force.

(6) The motor ECU is provided with a program for determining whether or not the differential computed at Step S32 is high (the ratio R is small). A torque error is compensated (the correction coefficient KV is updated) at Step S36a only when it is determined at Step S33 that the differential is high. This makes it possible to carry out the above torque correction only when especially required, that is, only when the differential is high. As a result, it is possible to achieve both the enhancement of correction accuracy and reduction of processing load.

(7) At Step S36a, a torque error with time in the assist electric motor 28 is sequentially compensated. The correction coefficient KV is sequentially updated. The motor ECU is further provided with a program for determining whether or not the cumulative amount of this sequential compensation is large, and a program for carrying out predetermined fail-safe processing when it is determined by the above program that the amount of compensation is large. This makes it possible to detect that the degree of deterioration in the assist electric motor 28 has become too serious to cope with by correction, and carry out the predetermined fail-safe processing.

(8) The predetermined fail-safe processing is processing of notifying that the cumulative amount of compensation for the torque of the assist electric motor 28 is large. This notification is carried out by turning on a warning lamp, sounding a buzzer, transmitting an abnormal signal such as an error message, or other like measure. This makes it possible to prevent abnormal operation of the assist electric motor 28 and the like, and enhance the level of security of the entire control system.

The invention is not limited to the above-mentioned embodiment, and may be embodied as follows, for example:

The mode of the fail-safe processing carried out at Step S36b is not limited to the above embodiment, and the most suitable mode can be adopted according to the specifications of the engine or the like. However, this fail-safe processing is dispensable, and the processing of Step S36b associated with this fail-safe processing, together with the determination processing at Step S36, may be omitted, provided that a use or the like does not require.

In the above embodiment, the correction coefficient KV is updated only when it is determined at Step S33 that the differential is high (the ratio R is small). Instead, the determination processing of Step S33 may be omitted, and the correction coefficient KV may be updated every time a ratio R is computed (Step S32).

In the above embodiment, the target voltage VA, one of signals outputted from the target setting unit 402, is corrected. However, the invention is not limited to this construction, and the target output AQ, one of signals inputted to the target setting unit 402 (signals sent from the engine ECU 30, in other words) may be corrected. In this case, however, the correction coefficient KV is determined as a correction coefficient related to power, not as a correction coefficient related to voltage.

In the above embodiment, the control target value (target voltage VA) is set higher than usual (control target value before correction). The invention is not limited to this construction. The control target value is kept unchanged and it is ensured that more power than this control target value is supplied to the assist electric motor 28.

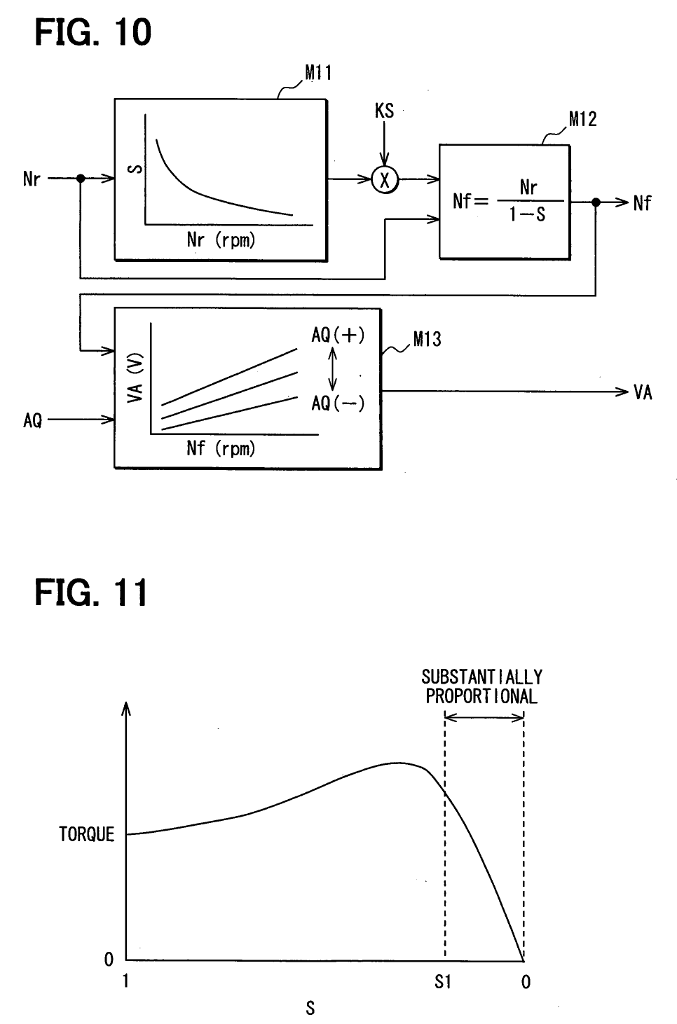

As illustrated in FIG. 10, the invention may be so constructed that the following is implemented with respect to the assist electric motor 28: a correction coefficient KS related to a slip (slip ratio S) equivalent to the speed difference between a synchronous speed (field speed) and the revolution speed of the rotor (rotor 28a) is determined; and the magnitude of the slip is corrected based on this correction coefficient KS. This makes it possible to easily and appropriately compensate a torque error based on the correlation between torque and slip. FIG. 11 schematically illustrates the relation between torque and slip (slip ratio S) observed when the voltage value (alternating-current voltage value) of the assist electric motor 28 is made constant.

As illustrate in FIG. 11, there is substantially proportional relation between torque and slip ratio S in a range in which the slip ratio S is small (a range in which the slip ratio S takes a value of “0 to S1”). In this range, the torque is increased with increase in slip ratio S. When a slip (slip ratio S) is corrected, for this reason, the correction coefficient KS can be easily obtained by utilizing this area in which the substantially proportional relation holds (using the electric motor 28 in this range). More specific description will be given. In this case, the relation between a ratio R (computed at Step S32) and a variation ΔKS of correction coefficient can be represented by a relational expression expressed as “KS=1/R.” Therefore, in place of the processing of Step S34, the processing of determining the variation ΔKS of correction coefficient from the ratio R based on this relational expression can be carried out. Thus, the correction coefficient KS can be updated at a subsequent step similarly with the case of the correction coefficient KV. When the magnitude of a slip is corrected with this correction coefficient KS, torque is also corrected.

When torque is corrected (a torque error is compensated), multiple different kinds of correction coefficients may be used together. For example, both the correction coefficient KV related to target voltage VA and the correction coefficient KS related to slip may be used.

The differential between a target power value (average target power PQ2) and an actual power value (average actual input power PD2) is not limited to a ratio, and any comparative value can be used instead. For example, the difference between them (e.g., “target power value−actual power value”) can be used.

The type of correction or the computation related to correction is not limited to multiplication by a correction coefficient, and any method can be used. For example, more precise correction may be carried out by arbitrarily combining computations, including the four fundamental operations of arithmetic (addition, subtraction, multiplication, and division), differentiation, integration, and the like.

A correction coefficient may be prepared with respect to each of the operating conditions (e.g., target power values) and the operating states (e.g., the revolution speeds of the turbocharger body 25) of the turbocharger body 25. An example will be taken. Correction coefficients KV1, KV2, KV3, . . . , KV7, KV8, KV9 are respectively correlated to the turbo revolution speeds Nr such as “20,000 rpm,” “40,000 rpm,” “60,000 rpm,” . . . , “140,000 rpm,” “160,000 rpm,” and “180,000 rpm (mapped). These maps are stored in an appropriate storage device (e.g., nonvolatile memory such as EEPROM). At Step S36a, the correction coefficient corresponding to the turbo revolution speed Nr at that time (on each occasion) is updated. When the turbo revolution speed Nr is 140,000 rpm, for example, the correction coefficient KV7 is updated. With this construction, the following can be implemented even when torque correction is frequently carried out: correction can be appropriately and accurately carried out on each occasion using a correction coefficient prepared with respect to each of the operating conditions or the operating states of the turbocharger body 25. As the correlating means, not only a map but also a relational expression or the like can be used.

In the above embodiment, target power values and actual power values are averaged, and an ultimate differential (ratio R) is obtained based on these averages. Instead, such a construction that the following is implemented may be adopted: the differential (ratio R) itself, not target power values or actual power values, is averaged, and this average value is taken as the ultimate differential (ratio R). Use itself of an average value is dispensable, and a construction in which an average value is determined is unnecessary when required accuracy is ensured.

The description of the above embodiment refers to a case where an alternating current-driven electric induction motor using a cage rotor is adopted as the assist electric motor 28. Basically, the invention is similarly applicable to a case where any other type of electric motor is used. Even in some other alternating-current electric motor including a wound-rotor type electric induction motor or a direct-current electric motor including a brushless motor, temperature (especially, service temperature environment) often has great influence on the life (the degree of deterioration) of the electric motor. For this reason, even when such an electric motor is adopted as the assist electric motor 28, the invention is usefully applicable.

The structure of a turbocharger with electric motor to be controlled is not limited to that illustrated in FIG. 2 as an example, and it is basically arbitrary. That is, the mode of installation (installation position, etc.) of the assist electric motor 28 and the like can also be arbitrarily established according to usage or the like.

It is essential that the intended purpose of suppressing degradation in output and continuously achieving stable operation of a turbocharger for a long time is accomplished by adopting a construction including the following means: means (e.g., program) for comparing a target power value and an actual power value and computing the differential between them; and means (e.g., program) for compensating a torque error of an assist electric motor arising from the differential based on the differential computed by the above means.

In the above embodiment, various types of software (programs) are used. Instead, the functions of these pieces of software may be carried out by hardware such as a dedicated circuit.

The description of the above embodiment takes as an example a case where the invention is applied to the common rail system of a vehicle diesel engine. However, the invention is not limited to this construction, and basically it can be similarly applied to, for example, spark ignition gasoline engines, including direct-injection engines, and the like.

What is claimed is:

1. A controller for a turbocharger with an electric motor which includes a turbocharger body performing a supercharging in an intake system and an assist electric motor assisting the turbocharger body in driving, the controller controlling an operation of the assist electric motor, comprising:
a differential computing means for comparing a target power value of the assist electric motor with an actual power value actually supplied to the assist electric motor, and computing a differential therebetween; and
a compensating means for compensating a torque error of the assist electric motor due to the differential based on the differential computed by the differential computing means.

2. A controller for a turbocharger with electric motor according to claim 1,
wherein the differential computing means computes the ratio between the target power value and the actual power value as the differential.

3. A controller for a turbocharger with electric motor according to claim 1,
wherein the compensating means corrects an amount of power supply to the assist electric motor.

4. A controller for a turbocharger with electric motor according to claims 1,
wherein the assist electric motor is an electric induction motor in which when alternating voltage is applied to a magnetic field, a force is produced by an action of a rotating magnetic field corresponding to the applied voltage and an induced current passed through a rotor in correspondence with the rotating magnetic field, and the rotor is rotated out of synchronization with a synchronous speed corresponding to a frequency of the applied voltage.

5. A controller for a turbocharger with electric motor according to claim 4,
wherein the compensating means corrects a magnitude of a slip corresponding to a speed difference between the synchronous speed and a revolution speed of the rotor.

6. A controller for a turbocharger with electric motor according to claim 1, further comprising:
a differential determining means for determining whether a differential computed by the differential computing means is high,
wherein the compensating means compensates the torque error when it is determined that a differential is high by the differential determining means.

7. A controller for a turbocharger with electric motor according to claim 1,
wherein the compensating means sequentially compensates degradation in the torque with time of the assist electric motor, the controller further comprising:
a compensation amount determining means for determining whether a cumulative amount of compensation by sequential compensation by the compensating means is large; and
a fail-safe means for performing a fail-safe processing when it is determined by the compensation amount determining means that an amount of compensation is large.

8. A controller for a turbocharger with electric motor according to claim 7,
wherein the predetermined fail-safe processing is for notifying that a cumulative amount of compensation for the torque of the assist electric motor is large.

9. A controller for a turbocharger with electric motor according to claim 1, further comprising:
a correlating means for respectively correlating correction coefficients related to a predetermined parameter with operating conditions or operating states of the turbocharger body,
wherein the compensating means corrects the predetermined parameter with the correction coefficient corresponding to an operating condition or an operating state of the turbocharger body on each occasion based on the correlating means in order to compensate the torque error.

10. A controller for a turbocharger with electric motor according to claim 9,
wherein the correlating means correlates a correction coefficient related to a predetermined parameter with each of the revolution speeds of the turbocharger body, and
the compensating means corrects the predetermined parameter with the correction coefficient corresponding to the revolution speed of the turbocharger body on each occasion based on the correlating means in order to compensate the torque error.
